(19) United States
(12) Patent Application Publication
(10) Pub. No.: US 2024/0257233 A1
(43) Pub. Date: Aug. 1, 2024

(54) PRIVACY-PRESERVING OVERDRAFT MANAGEMENT USING BLOCKCHAIN TECHNOLOGY

(71) Applicant: INTERNATIONAL BUSINESS MACHINES CORPORATION, ARMONK, NY (US)

(72) Inventors: Kaoutar El Khiyaoui, Zürich (CH); Angelo De Caro, Zürich (CH); Elli Androulaki, Zürich (CH)

(21) Appl. No.: 18/332,267

(22) Filed: Jun. 9, 2023

(30) Foreign Application Priority Data
Jan. 30, 2023 (GR) 20230100066

(51) Int. Cl. G06Q 40/02

(52) U.S. Cl. CPC G06Q 40/02; G06Q 2220/00

(57) ABSTRACT

The invention is notably directed to a computer-implemented method of managing user overdrafts in a privacy-preserving manner. The method comprises issuing a first overdraft token computed based on a user identifier of a given user, an initial overdraft value, a first serial number, and an encryption key that is shared with the given user. Next, the method generates a zero-knowledge proof of that said overdraft value is equal to a maximal value of credit granted to said given user. The method subsequently computes an overdraft issuance transaction based on the first overdraft token and the first zero-knowledge proof, signs the computed overdraft issuance transaction using a secret key that is not shared with the given user, and finally submits the overdraft issuance transaction to a blockchain for validation.

### TECHNICAL FIELD

The invention relates in general to the field of computer-implemented methods and computer program products for managing user overdrafts in a privacy-preserving manner, using blockchain technology.

### BACKGROUND

An overdraft is an extension of credit that can be granted by a financial institution (e.g., a bank) to a legal entity (e.g., a client) when this entity's account lacks sufficient funds (i.e., holdings reach a zero). This credit can for instance be used to cover withdrawals or payments from the account. The entity is then usually charged a fee, which typically depends on the amount of the overdraft used and its duration.

Overdrafts can easily be handled in account-based management models. However, such models are not privacy friendly as access patterns can be leaked. Management models based on so-called unspent transaction outputs (UTXOs) are more privacy friendly. However, such models do usually not allow financial institutions to detect when users go into overdraft.

Thus, there is a need for financial institutions to detect when users go into overdraft, yet without compromising user privacy. E.g., a commercial bank should only be able to trace overdraft-related information.

### SUMMARY

According to a first aspect, the invention is embodied as a computer-implemented method of managing user overdrafts in a privacy-preserving manner. The method comprises issuing a first overdraft token computed based on a user identifier of a given user, an initial overdraft value, a serial number, and an encryption key that is shared with the given user. Next, the method generates a zero-knowledge proof of that said overdraft value is equal to a maximal value of credit granted to the given user. The method subsequently computes an overdraft issuance transaction (also referred to as an “overdraft transaction” herein) based on the first overdraft token and the first zero-knowledge proof, signs the computed overdraft transaction using a secret key that is not shared with the given user, and finally submits the overdraft transaction to a blockchain for validation.

The above steps are key enablers of a privacy-preserving overdraft management scheme, which may include additional steps relating to validation, transfers, funding, and tracing operations. In particular, the present approach eventually allows a financial institution to trace overdraft-related operations based on the serial number.

The above steps are typically performed by an authorized overdraft issuer (e.g., an issuer authorized by a bank). So, the overdraft transaction is signed by the authorized overdraft issuer using a secret key of this authorized overdraft issuer. Next, the blockchain may validate the submitted overdraft transaction by checking that the submitted overdraft transaction is indeed signed by this authorized overdraft issuer and that the first zero-knowledge proof is a valid zero-knowledge proof.

Another aspect of the invention concerns a computer program for managing user overdrafts in a privacy-preserving manner. The computer program product comprises a computer readable storage medium having program instructions embodied therewith, where the program instructions are executable by processing means of a computerized system to cause the latter to perform steps according to the present methods.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 is a block diagram schematically illustrating various entities interacting with a blockchain according to one embodiment.

FIG. 2 is a flowchart illustrating high-level steps of an overdraft management method including steps related to the issuance of an overdraft token and the validation of a corresponding transaction by a blockchain according to one embodiments.

FIG. 3 is a flowchart illustrating high-level steps of an overdraft management method including operations related to transfers and corresponding validations as well as privacy-preserving tracing operations according to one embodiment.

FIG. 4 is a flowchart illustrating high-level steps of an overdraft management method including funding operations and corresponding validations according to one embodiment.

FIG. 5 schematically represents a general-purpose computerized system, suited for implementing one or more method steps as involved in embodiments of the invention.

Similar or functionally similar elements in the figures have been allocated the same numeral references, unless otherwise indicated. Computerized methods and computer program products embodying the present invention will now be described, by way of non-limiting examples.

### DETAILED DESCRIPTION OF EMBODIMENTS OF THE INVENTION

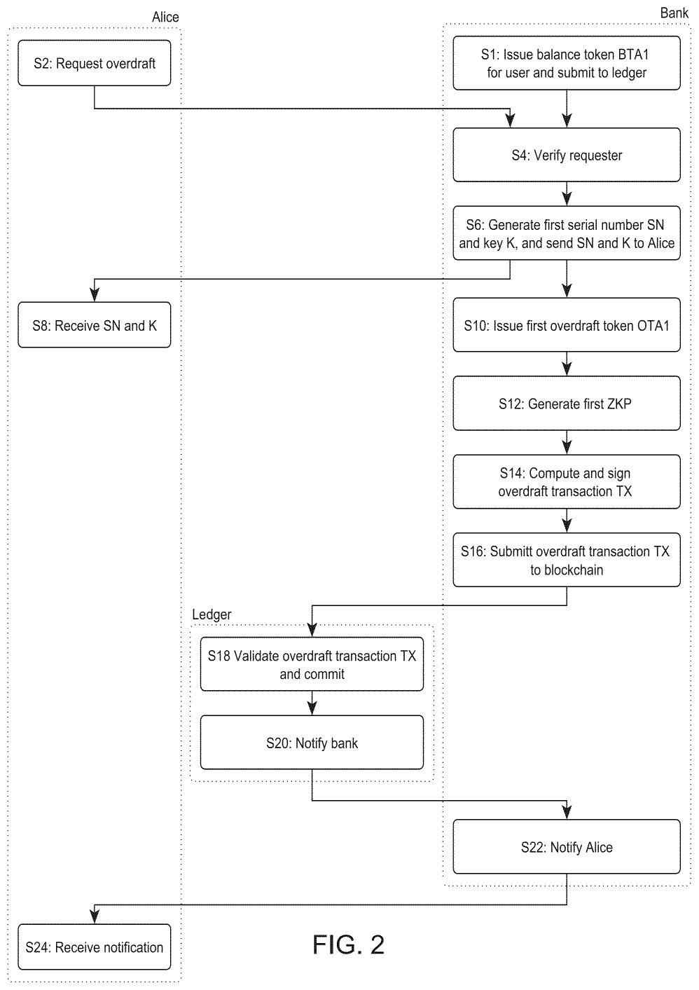

The following description is structured as follows. General embodiments and high-level variants are described in section 1. Section 2 addresses a particularly preferred scenario. Section 3 concerns technical implementation details. Note, the present method and its variants are collectively referred to as the “present methods”. All references Sn refer to methods steps of the flowcharts of FIGS. 2-4, while numeral references pertain to entities (or devices thereof) and systems involved in embodiments of the present invention.

### 1. GENERAL EMBODIMENTS AND HIGH-LEVEL VARIANTS

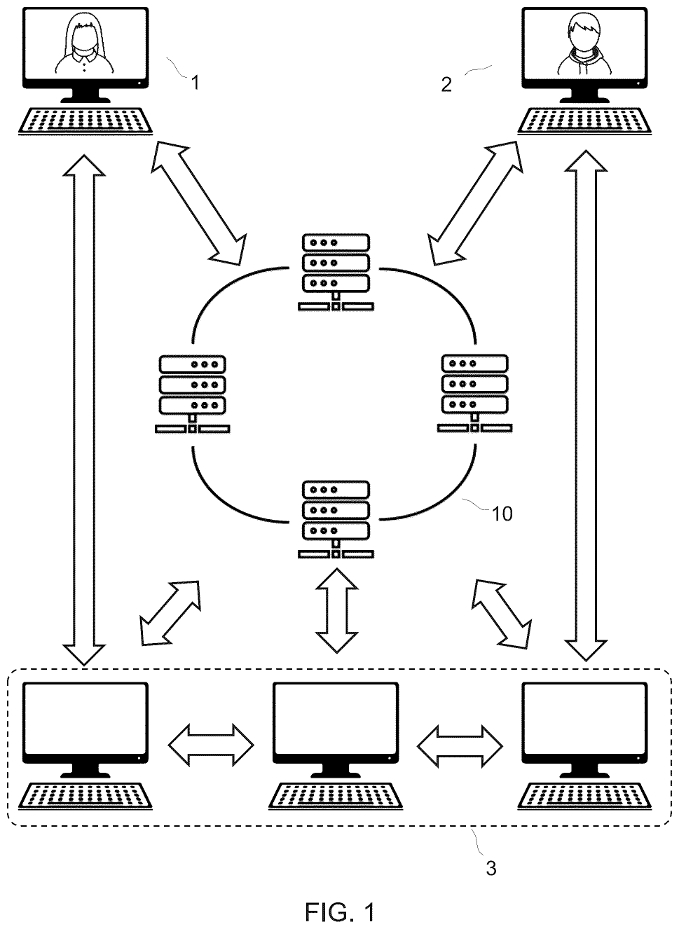

A first aspect of the invention is now described in detail, in reference to FIGS. 1 and 2. This aspect concerns a computer-implemented method of managing user overdrafts in a privacy-preserving manner. As noted in the background section, there is a need for financial institutions to detect when users go into overdraft, yet without compromising user privacy. Now, a deeper question that remains is how to devise key enablers of a privacy-preserving overdraft management scheme.

### 1.1. Overdraft Issuance and Validation

### 1.1.1. Issuance

An elegant, simple, and efficient solution to this problem is discussed below in detail. This solution relies on the issuance of an overdraft token, which is generated based on specific information allowing the traceability of overdrafts (in a privacy-preserving manner), the generation of a corresponding transaction (encompassing a zero-knowledge proof of critical components of the transaction), and its submission to a blockchain for subsequent validation.

The context assumed is the following. The management of bank records relies on a blockchain system 10 (also referred to as blockchain 10), i.e., a shared ledger. Various entities interact with each other, whether via the blockchain 10 or directly, as illustrated in FIG. 1. Such entities include a financial institution 3 (e.g., a bank) and/or an authorized issuer (i.e., an issuer acknowledged by the financial institution 3), as well as users 1, 2. In FIG. 1, the issuer and the bank are considered to form part of a same entity 3, for simplicity. The bank may regularly issue balance tokens BTA1 in respect of users 1, 2 (as in step S1 of FIG. 2). A balance token captures a cash balance. At any time, a given user 1 may request (step S2, FIG. 2) an overdraft to a bank 3, should the user holdings reach a zero. In that case, the bank will likely verify S4 the user request and the user identity, before generating S6 elements that will later enable a privacy-preserving overdraft management scheme.

In the present context, such elements include a serial number SN and an encryption key K. This encryption key K is shared with the user 1 (call her “Alice”). Once generated, these elements may for instance be sent S8 to Alice and stored on Alice's device. All the more, such elements are used to issue S10 a first overdraft token OTA1. This token is computed based on the serial number SN, the shared encryption key K, an identifier (“Alice”) of the user 1, and an initial overdraft value, which corresponds to a maximal value (MaxVal) of credit granted to Alice.

The method subsequently generates S12 a first zero-knowledge proof, meant to prove that the initial overdraft value (as encoded in the token OTA1) is equal to the maximal value MaxVal of credit as granted to Alice 1. A corresponding transaction TX is computed at step S14. The overdraft issuance transaction TX (referred to as an “overdraft transaction” in the following) is computed based on the first overdraft token OTA1 and the first zero-knowledge proof. This transaction TX is signed S14 using a secret key, i.e., one that is not shared with the user 1. The overdraft transaction TX is eventually submitted S16 to the blockchain 10 for subsequent validation. Note, step S1 (FIG. 2) is not a prerequisite to the overdraft issuance; it just reflects the fact that users receive balance tokens from issuers, something that is independent from the overdraft management.

Comments are in order. The overdraft token OTA1 is computed as a hiding commitment pertaining to a user identifier, an overdraft value, a serial number, and an encryption key K. This can be noted OTA1=com(Alice, MaxVal, SN, K). More generally, all overdraft tokens evoked herein are designed as hiding commitments. Each commit operation consists of recording a transaction in the blockchain 10. The blockchain is a distributed system configured as a shared ledger. It may possibly be configured as a business blockchain such as the so-called Hyperledger Fabric, or a similar blockchain relying on a consensus algorithm that is less compute-intensive than the so-called Proof-of-Work variant.

The blockchain 10 is assumed to be in data communication with all relevant parties, e.g., users 1, 2, including transaction beneficiaries 2, banks 3 and/or auth issuers, etc.). Such transactions are electronic transactions, which are meant to be electronically recorded in a blockchain 10. That is, each transaction is meant to be included in a block to be added to the blockchain 10. The transaction content is recorded in an obfuscated state in the blockchain. i.e., the transaction's content is obfuscated before being submitted to the blockchain. Various zero-knowledge proofs (or ZKPs for short) may be involved, as in embodiments described below. Such ZKPs are preferably computed as executable instructions (or compiled code), as known per se.

The above steps S10-S16 are key enablers of a privacy-preserving overdraft management scheme, which may typically include additional steps, e.g., relating to transfers and tracing operations (Sect. 1.2), funding (Sect. 1.3), and corresponding validations, as discussed in detail in the following sections. Such steps notably allow a financial institution to simply trace overdraft-related operations based on the serial number SN. Remarkably, the proposed management scheme preserves privacy. That is, the present approach provides a ledger-based solution that allows a system (e.g., of a financial institution) to detect overdrafts and trace overdraft-related operations, while preserving privacy of the users 1, 2.

### 1.1.2. Validation

The above steps S10-S16 can be performed by any authorized entity, e.g., whether the bank 3 itself or an authorized issuer. In embodiments, such steps are performed by an authorized overdraft issuer, as mostly assumed in the following. So, the overdraft transaction may possibly be signed S14 by the authorized issuer using a secret key of this issuer. The overdraft transaction TX is then submitted S16 by the issuer to the blockchain 10 for it to validate S18 the transaction.

The blockchain 10 validates S18 the submitted overdraft transaction TX by checking that: (i) the first ZKP is a valid ZKP; and (ii) the submitted overdraft transaction is indeed signed by this authorized overdraft issuer 3. The overdraft transaction TX is normally verified using a public key of the issuer. In passing, the blockchain may ascertain the public key thanks to a digital certificate issued for this public key. Any suitable public key infrastructure (PKI) may be involved. This way, a valid transaction operation is committed to by the issuer. After having validated S18 the transaction TX, the ledger may possibly notify S20 the issuer or the bank (as assumed in FIG. 2). In turn, the issuer (or the bank) may accordingly notify S22 Alice, who receives a notification at step S24.

### 1.2. Managing Transfers in Overdraft

### 1.2.1. Transfer

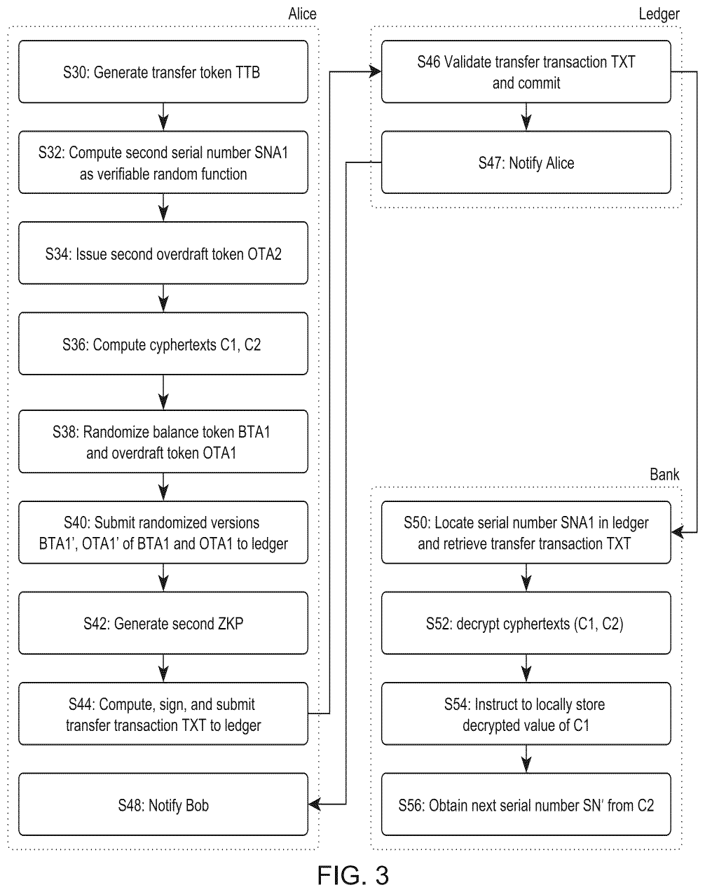

Assume that, despite being overdrawn, Alice 1 wants to transfer money to another user 2 (call him “Bob”). FIG. 3 shows a flow allowing such transfers to be managed in a privacy-preserving context. Assume further that a balance token BTA1 has previously been issued (see step S1, FIG. 1) for Alice 1. This balance token has been obtained based on the user identifier “Alice”, a balance value, and a first seed SA1.

A series of steps can now be taken on Alice's side, with a view to performing, validating, and suitably tracing a transfer. Note, such steps can be performed by Alice's device 1 or by another device, yet in the name of and on behalf of Alice. To that aim, a transfer token TTB is first generated at step S30. This token TTB is computed based on an identifier of the transfer beneficiary 2 (namely Bob), a second seed SB, and a value of the amount to be transferred.

In the following, and the for the sake of illustration, this amount is assumed to be equal to $100, while the latest balance value indicate holdings equal to $80. Assume further that the bank has allowed a maximal credit value (MaxVal) of $30, which makes it possible to cover the intended transfer. That is, BTA1=com(“Alice”, 80, SA1), while TTB=com(“Bob”, 100, SA1). Next, a second serial number SNA1 is computed S32 as a verifiable random function (noted vrf) of the secret key SKA of Alice 1 and the first seed SA1. i.e., SNA1=vrf(“Alice”, SA1).

At present, a second overdraft token OTA2 can be generated S34 based on the user identifier (“Alice”), a residual credit value, a third serial number SN′, and the encryption key K. The residual credit value is obtained based on the initial overdraft value (i.e., $30) minus a difference between the transfer value ($100) and the balance value ($80). So, the residual credit value is here equal to $10. That is, OTA2=com(“Alice”, 10, SN′, K). Next, two cyphertexts C1, C2 are computed S36 thanks to the encryption key K. The two cyphertexts consist of a first cyphertext C1, which encrypts the residual credit value (equal to $10 in the above example), and a second cyphertext C2, which encrypts the third serial number SN′.

The next step S38 amounts to randomizing S38 the balance token BTA1 and the first overdraft token OTA1. The outcomes of this step are a randomized balance token, noted BTA1′, and a randomized, first overdraft token, noted OTA1′. The randomized versions of the tokens will later be submitted S40 to the blockchain 10, as part of a more general transaction, which further requires generating S42 a second ZKP. The latter is devised with a view to proving that: (i) BTA1′ and OTA1′ correspond to randomized versions of BTA1 and OTA1 as stored in the ledger (ii) OTA1′ encodes the first serial number SN, (iii) each of the second serial number SNA1, the first cyphertext C1, and the second cyphertext C2, is correctly computed, and (iv) the values involved are consistent. That is, the second ZKP must prove that the sum of the balance value (i.e., $80) as captured in BTA1′ and the initial overdraft value ($30) as in OTA1′ matches the sum of the transfer value ($100) in TTB and the residual credit value ($10) in OTA2. In addition, the second ZKP is designed to prove that: (v) the residual credit value ($10) in OTA2 is less than or equal to the maximal value MaxVal of credit (i.e., $30); and (vi) the user identifier (“Alice”) in OTA2 corresponds to the user identifier as mentioned in each of BTA1′ and OTA1′.

Note, in principle, the second ZKP may be devised as multiple, concurrently verifiable ZKPs. However, it is preferably generated S42 as a single ZKP, directly computable and verifiable, for the sake of efficiency.

Eventually, a transfer transaction TXT can be generated S44 based on the first serial number SN, the second serial number SNA1, the randomized balance token BTA1′, the transfer token TTB, the first (randomized) overdraft token OTA1′, the second overdraft token OTA2, each of the two cyphertexts C1, C2, and the second ZKP. i.e., TXT=(SN, SNA1, BTA1′, TTB, OTA1′, OTA2, C1,C2, ZKP2). This transaction TXT is then signed S44 anonymously, using the secret key SKA of Alice 1, and submitted S44 to the blockchain 10.

### 1.2.2. Transfer Validation

At step S46, the blockchain 10 validates the transfer transaction TXT by checking S46 that: (i) each of the first serial number SN and second serial number SNA1 does not appear in any transaction as previously recorded in the blockchain 10 in respect of Alice 1, (ii) the second ZKP is a valid ZKP, and (iii) the signed overdraft transaction TX is compatible with the user identifier (“Alice”) as in BTA1′ and OTA1′. The reason for checking the first and second serial numbers SN, SNA1 is to prevent double spending. The last check amounts to verifying that the overdraft transaction TX has been duly signed by or for Alice as identified in the randomized versions BTA1′ and OTA1′ of the balance token BTA1 and the first overdraft token OTA1, to prove that the transaction was initiated by or for the rightful user, Alice in that case. In addition, the second ZKP is checked to be a valid ZKP, for consistency. Anyone can verify the transfer transaction TXT was signed by the rightful owner (i.e., Alice), while otherwise respecting Alice's anonymity, since TXT does not reveal Alice. After having validated the transfer transaction TXT, the blockchain 10 may possibly notify S47 Alice, who may in turn, notify

S48 Bob.

### 1.2.3. Privacy-Preserving Tracing of Operations

In general, all relevant transactions can be traced by a legitimate entity 3 based on the first serial number SN. For example, transfer-related transactions can be traced S50-S56 by first locating S50 the first serial number SN (in the blockchain 10) and accordingly retrieving S50 the transfer transaction TXT from the blockchain 10. Next, this entity 3 may decrypt S52 each of the two cyphertexts C1, C2 (thanks to the encryption key K as initially shared with the user 1). This gives rise to two decrypted values, respectively corresponding to the residual credit value (i.e., $10) and the third serial number SN′. The first decrypted value is typically stored S54 locally, typically in the form (“Alice”, block_height, 10), for reasons that will become apparent in Sect. 2. The second decrypted value obtained S56, i.e., the third serial number SN′, makes it possible to retrieve the second overdraft token OTA2. This way, successive tokens can be traced by an authorized entity 3, while preserving the confidentiality of the users concerned.

### 1.3. Funding

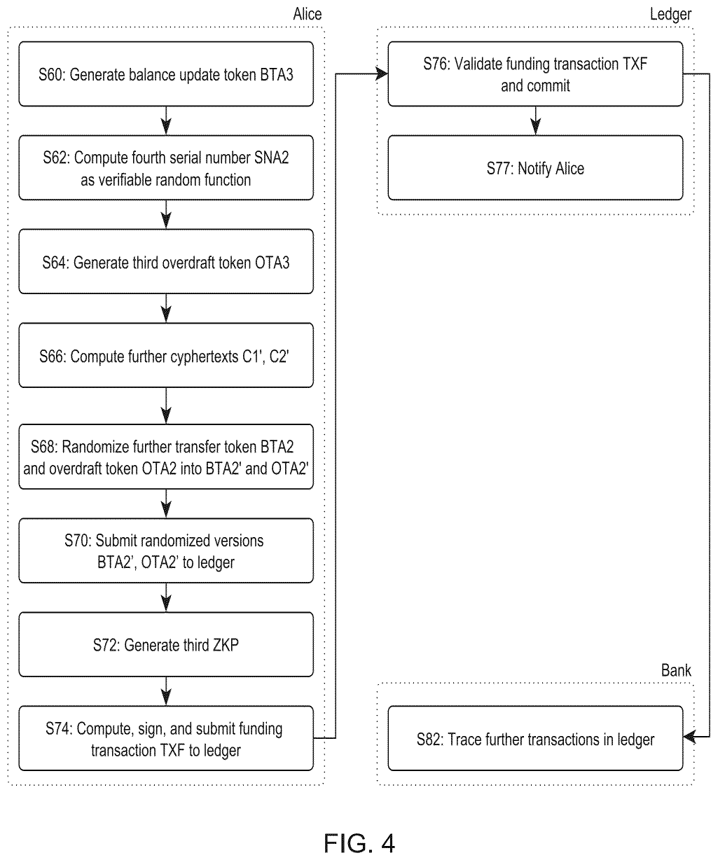

Additional steps concern the funding of the overdraft, as illustrated in the flow of FIG. 4. Assume that Alice has now received $35. Correspondingly, a further transfer token BTA2 may have been generated for Alice 1. This token BTA2 can be obtained based on the user identifier (“Alice”), a further transfer value (corresponding to $35 in the above example), and a third seed SA2. That is, BTA2=com(“Alice”, 35, SA2). Accordingly, a balance update token BTA3 can be generated S60 based on the user identifier (“Alice”), a fourth seed SA3, and an updated balance value (i.e., corresponding to $15=$35-($100-$80)). That is, this values corresponds to the further transfer value ($35) minus the difference between the previously transferred value $100 and the previous balance value $80.

The reason for doing so is that, in the beginning, each user 1 may possibly obtain an overdraft token whose value corresponds to MaxVal. Now, the funding transaction uses a balance token to top up the overdraft token. The corresponding transaction takes as input the balance token and the overdraft token, and outputs an overdraft token whose value corresponds to either MaxVal or the sum of the value of the overdraft token in the input and the value of the balance token, whichever is smaller.

Next, a fourth serial number SNA2 is computed S62 as a verifiable random function of the secret key SKA of Alice 1 and the third seed SA2. i.e., SNA2=vrf(“Alice”, SA2).

At present, a third overdraft token OTA3 is generated S64. This token OTA3 is computed based on the user identifier (“Alice”), the maximal value MaxVal of credit (i.e., $30), a fifth serial number SN″, and the encryption key K. In addition, two additional cyphertexts C1′, C2′ are computed at step S66, thanks to the encryption key K. These additional cyphertexts consist of C1′, which encrypts the maximal value MaxVal of credit, and C2′, which encrypts the fifth serial number SN″.

At step S68, the further transfer token BTA2 and the second overdraft token OTA2 are randomized, giving rise to randomized versions thereof, noted BTA2′ and OTA2′. Such randomized versions BTA2′ and OTA2′ of the tokens BTA2 and OTA2 are subsequently submitted S70 to the blockchain 10.

As before, one or more third ZKPs can subsequently be generated S72. Such ZKPs aim at proving that: (i) BTA2′ and OTA2′ correspond to randomized versions of BTA2 and OTA2 as stored in the ledger; (ii) OTA2′ encodes the third serial number SN′; (iii) SNA2, C1′, and C2′ are correctly computed; (iv) the sum of values encoded in OTA2′ and BTA2′ matches the sum of values in BTA3 and the third overdraft token OTA3; and (v) the maximal value MaxVal in OTA3 is less than or equal to the maximal value MaxVal of credit as initially granted to Alice 1. That is, the transaction should result in an overdraft token of value MaxVal. For completeness, the third ZKP(s) must prove that (vi) the user identifier in OTA3 corresponds to the user identifier in OTA2′, BTA2′ and BTA3. Again, the third ZKP(s) are preferably generated S72 as a single ZKP.

Finally, a funding transaction TXF can be computed S74 based on the third serial number SN′, the fourth serial number SNA2, the randomized version BTA2′ of the further transfer token BTA2 and the randomized version OTA2′ of the second overdraft token OTA2, the third overdraft token OTA3, the balance update token BTA3, each of the two additional cyphertexts C1′, C2′, and the third ZKP(s). Again, this transaction TXF is anonymously signed S74 using the secret key SKA of Alice 1. The funding transaction TXF, as signed, is finally submitted S74 to the blockchain 10, for validation.

Like steps S30-S48, steps S60-S74 are typically performed by Alice's device 1 or by another device, yet in the name of and on behalf of Alice. The validation S76 is similar to that of step S46. i.e., the blockchain 10 validates S76 the transaction TXF by checking that: (i) neither SN′ nor SNA2 appears before in any transaction previously recorded in respect of Alice 1; (ii) the third ZKPs are valid ZKPs; and (iii) the signed overdraft transaction TX, as submitted to the blockchain 10, is compatible with the user identifier (“Alice”) as in BTA2′ and OTA2′. Alice is subsequently notified by the ledger (step S77). From this point on, the bank may trace S82 funding-related transactions, following the same principles as described earlier.

According to another aspect, the invention can also be embodied as a computer program product for managing user overdrafts in a privacy-preserving manner. The computer program product comprises a computer readable storage medium having program instructions embodied therewith, where the program instructions can be executed by processing means of a computerized system to cause the latter to perform steps in accordance with the present methods. The computerized system at stake may for instance be a system of an authorized overdraft issuer, as explained earlier. Additional features of the present computer program products are discussed in Sect. 3.

### 2. PARTICULARLY PREFERRED EMBODIMENT

This section describes a preferred method to enable privacy-preserving overdraft management for UTXO-based systems, where an issuer issues currency tokens to users, while commercial banks grant user lines of credit in the form of overdraft tokens. The users receive currency tokens from the issuer and overdraft tokens from the commercial banks. A ledger validates and stores transaction from the issuer, commercial banks, and users, and can also be used as a timestamping service.

This method revolves around extending UTXO-based privacy-preserving token systems with three transactions that enable privacy-preserving overdraft management.

Overdraft issuance. A commercial bank uses overdraft issuance to create an overdraft token OTA1 for a user (Alice). The overdraft token is a hiding commitment defined by an owner corresponding to Alice's identity, the maximal value MaxVal of the credit granted to Alice, a unique serial number SN, and an encryption key K shared with Alice. Once the overdraft token is issued, Alice can use it to fund her transfer transactions should she lacks funds.

Transfer with overdraft. Assume that Alice would like to transfer $100 to Bob. Alice, however, only has $80 in her funds. Accordingly, Alice uses her overdraft token OTA1 of value $MaxVal to get the missing $20. The transfer from Alice to Bob will consume Alice's balance token BTA1 of value $80 and her overdraft token, and create a transfer token TTB of value $100 for Bob and a new overdraft token OTA2 for Alice, the value of which is now the value of the consumed overdraft token minus $20 (i.e., $MaxVal−20). The transfer transaction reveals the serial numbers of the tokens being consumed to prevent double spending (i.e., SN and SNA1) and creates the transfer token TTB for Bob in a way that preserves the transfer privacy, whereas the new overdraft token OTA2 is created as follows. OTA2 encodes Alice's as the owner, a value equaling the value of the old overdraft token minus $20, a new unique serial number SN′ and the same encryption key K as in the old overdraft token. The transfer transaction includes two ciphertexts C1 and C2, obtained using the encryption key in the overdraft token. C1 encrypts the value of the new overdraft token and C2 encrypts the serial number SN′. The transfer transaction further contains a ZKP showing that the transaction is well-formed. That is, it was initiated by the owner of the consumed tokens OTA1 and BTA1, the consumed tokens are stored in the ledger, the ciphertexts, new tokens and revealed serial numbers are correctly computed, the total value of the consumed token equals the total value of created tokens, and the value of the new overdraft token is less or equal to MaxVal.

Overdraft funding. Assume that Alice now has a further transfer token BTA2 of value 35 (whereas her overdraft token OTA2 is of value MaxVal−20) and would like to fund her overdraft. To that end, Alice creates an overdraft funding transaction. This transaction will consume the overdraft token OTA2 and the further transfer token BTA2, and create a new overdraft token whose value equals the value of the old overdraft token OTA1 plus 20 (i.e., corresponding to MaxVal) and a new balance update token BTA3 for Alice with value 15. The transaction includes two ciphertexts C1′ and C2′ that encrypt the value of the new overdraft token and its serial number SN″. The transaction reveals the serial numbers SN′ and SNA2 of the consumed tokens to prevent double spending. The transaction also carries a ZKP showing that the transaction is well-formed. That is, it was initiated by the owner of the consumed tokens (OTA2 and BTA2), the consumed tokens are stored in the ledger, the ciphertexts, new tokens and revealed serial numbers are correct, the total value of consumed token equals the total value of created tokens, and the value of the new overdraft token is less or equal to MaxVal.

These transactions are submitted to the ledger for validation and storage. The above method allows commercial banks to trace the overdraft use. Assume Alice's bank wants to trace Alice's overdraft use. The commercial bank proceeds as follows:
a) Given the initial serial number SN of Alice's overdraft token, the commercial bank checks if that serial number appears in the ledger, if not, then this means that Alice did not use the allowed overdraft;
b) Else, the bank retrieves the corresponding transaction and decrypts the ciphertext encrypting the new value of the overdraft and the ciphertext encrypting the overdraft's new serial number;
c) The bank then stores the new value of the overdraft and the corresponding timestamp (e.g., block height in the ledger);
d) The bank subsequently looks up the new serial number SN′. If the serial number does not exist, then the commercial bank stops; and
e) Else, the bank repeats steps b), c) and d), which allows the bank to trace Alice's overdraft use successfully.

### 3. TECHNICAL IMPLEMENTATION DETAILS AND FINAL REMARKS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

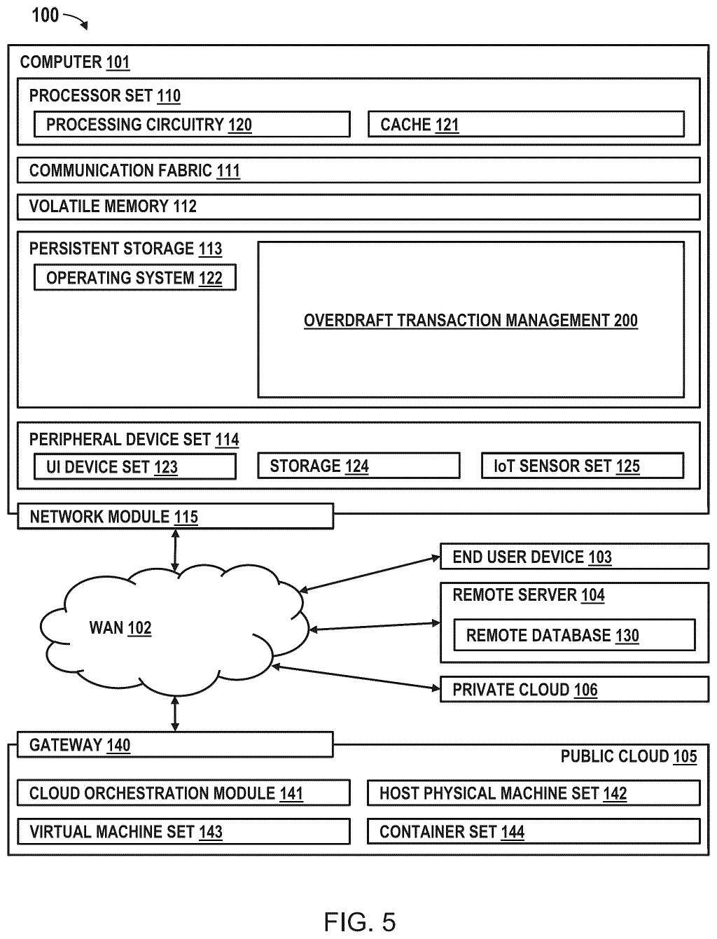

In FIG. 5, the computing environment 100 contains an example of an environment for the execution of at least some of the computer code involved in performing the inventive methods 200, such as the token issuance and transaction generation processes discussed in Sect. 1. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located off chip. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated.

What is claimed is:

1. A computer-implemented method of managing user overdrafts in a privacy-preserving manner, wherein the method comprises:
issuing a first overdraft token computed based on a user identifier of a given user, an initial overdraft value, a first serial number, and an encryption key that is shared with the given user;
generating a first zero-knowledge proof of that said initial overdraft value is equal to a maximal value of credit granted to said given user;
computing an overdraft transaction based on the first overdraft token and the first zero-knowledge proof and signing the computed overdraft transaction using a secret key that is not shared with the given user; and
submitting the overdraft transaction to a blockchain.

2. The computer-implemented method according to claim 1, further comprising:
wherein the overdraft transaction is signed by an authorized overdraft issuer using said secret key, and wherein said secret key is associated with said authorized overdraft issuer, and wherein, at the blockchain, validating the submitted overdraft transaction by checking that,
the submitted overdraft transaction is signed by said authorized overdraft issuer, and
the first zero-knowledge proof is a valid zero-knowledge proof.

3. The computer-implemented method according to claim 1, wherein the method further comprises:
given a balance token issued for said given user, wherein the balance token has been obtained based on the user identifier, a balance value, and a first seed, generating a transfer token based on a transfer beneficiary identifier, a transfer value, and a second seed, and
computing a second serial number as a verifiable random function of a secret key of the given user and the first seed.

4. The computer-implemented method according to claim 3, wherein the method further comprises:
generating a second overdraft token based on the user identifier, a residual credit value, a third serial number, and the encryption key, wherein the residual credit value has been obtained based on the initial overdraft value minus a difference between said transfer value and said balance value; and
computing two cyphertexts thanks to the encryption key, the cyphertexts including
a first cyphertext encrypting the residual credit value, and
a second cyphertext encrypting the third serial number.

5. The computer-implemented method according to claim 4, further comprising:
randomizing the balance token and the first overdraft token to respectively obtain a randomized balance token and a randomized, first overdraft token.

6. The computer-implemented method according to claim 5, wherein further comprising:
generating one or more second zero-knowledge proofs showing that:
the randomized balance token and the randomized, first overdraft token correspond to randomized versions of each of the balance token and the first overdraft token as stored in the blockchain;
the randomized, first overdraft token encodes the first serial number;
each of the second serial number, the first cyphertext, and the second cyphertext, is correctly computed;
a sum of the balance value as in the randomized balance token and the initial overdraft value as in the randomized, first overdraft token matches a sum of the transfer value as in the transfer token and the residual credit value as in the second overdraft token;
the residual credit value as in the second overdraft token is less than or equal to said maximal value of credit; and
the user identifier as in the second overdraft token corresponds to the user identifier as in each of the randomized balance token and the randomized, first overdraft token.

7. The computer-implemented method according to claim 6, wherein the one or more second zero-knowledge proofs are generated as a single zero-knowledge proof.

8. The computer-implemented method according to claim 6, further comprising:
generating a transfer transaction based on the first serial number, the second serial number, the randomized balance token, the transfer token, the randomized, first overdraft token, the second overdraft token, each of the two cyphertexts, and the one or more second zero-knowledge proofs;
anonymously signing the transfer transaction using the secret key of the given user; and
submitting the transfer transaction, as signed, to the blockchain.

9. The computer-implemented method according to claim 8, further comprising:
validating the transfer transaction at the blockchain by checking that:
each of the first serial number and second serial number does not appear in previous transactions recorded in the blockchain in respect of the given user,
the one or more second zero-knowledge proofs are valid zero-knowledge proofs, and
the signed overdraft transaction, as submitted to the blockchain, is compatible with the user identifier as in the randomized balance token and the randomized, first overdraft token.

10. The computer-implemented method according to claim 8, further comprising:
tracing overdraft-related operations based on the first serial number.

11. The computer-implemented method according to claim 10, wherein tracing the overdraft-related operations further comprises:
locating the first serial number in the blockchain and accordingly retrieving the transfer transaction from the blockchain;
decrypting, thanks to the encryption key, each of the two cyphertexts to obtain a first decrypted value and a second decrypted value,
storing the first decrypted value, and
obtaining, from the second decrypted value, the third serial number, so as to be able to retrieve the second overdraft token.

12. The computer-implemented method according to claim 9, further comprising:
given a further transfer token generated for said given user, wherein the further transfer token has been obtained based on the user identifier, a further transfer value, and a third seed, generating a balance update token based on the user identifier, a fourth seed, and the further transfer value minus a difference between said transfer value and said balance value, and
computing a fourth serial number as a verifiable random function of the secret key of the given user and the third seed.

13. The computer-implemented method according to claim 12, further comprising:
generating a third overdraft token computed based on the user identifier, said maximal value of credit, a fifth serial number, and the encryption key; and
computing two additional cyphertexts thanks to the encryption key, the additional cyphertexts including
a first additional cyphertext encrypting said maximal value of credit, and
a second additional cyphertext encrypting the fifth serial number.

14. The computer-implemented method according to claim 13, further comprising:
randomizing the further transfer token to obtain a randomized, further transfer token; and
randomizing the second overdraft token to obtain a randomized, second overdraft token.

15. The computer-implemented method according to claim 14, further comprising:
generating one or more third zero-knowledge proofs showing that:
the randomized, further transfer token and the randomized, second overdraft token correspond to randomized versions of each of the further transfer token and the second overdraft token as stored in the blockchain;
the randomized, second overdraft token encodes the third serial number;
each of the fourth serial number, the first additional cyphertext, and the second additional cyphertext, is corrected computed;
a sum of values encoded in the randomized, second overdraft token and the randomized, further transfer token matches a sum of values as in the balance update token and the maximal value of credit as in the third overdraft token;
the maximal value as in the third overdraft token is less than or equal to the maximal value of credit as initially granted to the given user; and
the user identifier as in the third overdraft token corresponds to the user identifier as in each of the randomized, second overdraft token, the randomized, further transfer token, and the balance update token.

16. The computer-implemented method according to claim 15, wherein the one or more third zero-knowledge proofs are generated as a single zero-knowledge proof.

17. The computer-implemented method according to claim 15, further comprising:
computing a funding transaction based on the third serial number, the fourth serial number, the randomized, further transfer token, the balance update token, the randomized, second overdraft token, the third overdraft token, each of the two additional cyphertexts, and the one or more third zero-knowledge proofs,
anonymously signing the funding transaction using the secret key of said given user, and
submitting the funding transaction, as signed, to the blockchain.

18. The computer-implemented method according to claim 17, wherein the method further comprises, at the blockchain, validating the funding transaction by checking that:
each of the third serial number and fourth serial number does not appear before in any transaction previously recorded in respect of the given user;
the one or more third zero-knowledge proofs are valid zero-knowledge proofs, and
the signed overdraft transaction, as submitted to the blockchain, is compatible with the user identifier as in the randomized, further transfer token and the randomized, second overdraft token.

19. A computer program product for managing user overdrafts in a privacy-preserving manner, the computer program product comprising a computer readable storage medium having program instructions embodied therewith, the program instructions executable by a processor associated with a computerized system to cause the computerized system to perform a method comprising:
issuing a first overdraft token computed based on a user identifier of a given user, an initial overdraft value, a first serial number, and an encryption key that is shared with the given user;
generating a first zero-knowledge proof of that said initial overdraft value is equal to a maximal value of credit granted to said given user;
computing an overdraft transaction based on the first overdraft token and the first zero-knowledge proof and signing the computed overdraft transaction using a secret key that is not shared with the given user; and
submitting the overdraft transaction to a blockchain.

20. The computer program according to claim 19, wherein the computerized system is a system of an authorized overdraft issuer and said secret key is a secret key of said authorized overdraft issuer, whereby the overdraft transaction is signed by said authorized overdraft issuer, in operation.
